(19) United States
(12) Patent Application Publication
(10) Pub. No.: US 2022/0314745 A1
(43) Pub. Date: Oct. 6, 2022

(54) INSTRUMENT PANEL ASSEMBLY INTEGRATED WITH DISPLAY AND VENTILATION OUTLETS AND INLETS, AND VEHICLE WITH INSTRUMENT PANEL

(71) Applicant: FOXCONN INTERCONNECT TECHNOLOGY LIMITED, Grand Cayman (KY)

(72) Inventor: CHIA-YEN LEE, New Taipei (TW)

(21) Appl. No.: 17/564,545

(22) Filed: Dec. 29, 2021

(30) Foreign Application Priority Data
Mar. 30, 2021 (CN) 202110342993.0

(51) Int. Cl. B60H 1/34; B60K 37/04; B60H 1/00

(52) U.S. Cl. CPC B60H 1/345; B60K 37/04; B60H 1/3414; B60H 1/00564; B60K 2370/152; B60K 2370/658; B60H 2001/00614

(57) ABSTRACT

An instrument panel including a potentially large display panel which can be recessed away from mis-operations includes mounting surface and air outlet assembly. The display panel is mounted on the mounting surface. The air outlet assembly includes air intake and outlet. The air intake can connect to an air conditioning system. The air outlet is disposed on the mounting surface, and contains the display terminal. A size of the display assembly is freely adjustable, and the structure of the instrument panel reduces a risk of mis-operating the display terminal while driving. Heat generated by the display terminal can be taken away by the air outlet for increasing a lifetime of the display terminal. A vehicle with the instrument panel is also provided.

### FIELD

The subject matter herein generally relates to vehicle construction, specifically to an instrument panel assembly integrated with a display and an air outlet and a vehicle with the instrument panel.

### BACKGROUND

The controls in front of a driver usually include a display, air outlets, physical buttons, and storage spaces. The display provides a human-computer interaction, such as navigation function, video play function, remote control of media function through a connected mobile phone. The air outlets provide hot or cold airflow. In a vehicle construction, an arrangement of the display and the air outlets may be problematic in a limited space. The air outlets can be disposed below the display, upon the display, or on opposite sides of the display. When the air outlets are below the display, the airflow is directly up to arms of the driver but cannot target the body of the driver. When the air outlets are upon the display, access to the display by the driver is restricted. When the air outlets are disposed on opposite sides of the display, the area available for the display is reduced.

Thus, there is room for improvement in the art.

### BRIEF DESCRIPTION OF THE DRAWINGS

Implementations of the present disclosure will now be described, by way of example only, with reference to the attached figures.

FIG. 1 is a diagram illustrating an embodiment of an instrument panel assembly in place to face the driver, according to the present disclosure.

FIG. 2 is a diagram illustrating an embodiment of the instrument panel assembly of FIG. 1 in a plan view, according to the present disclosure.

FIG. 3 is a diagram illustrating an embodiment of a vehicle according to the present disclosure.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure. It will be understood that the specific embodiments described herein are merely some embodiments and not all.

The relationships of orientations or positions denoted by the terms of terms “center”, “longitudinal”, “lateral”, “length”, “width”, “thickness”, “up”, “down”, “left”, “right”, “horizontal”, “left”, “top”, “bottom”, “inside”, “outside”, “clockwise”, “anticlockwise” used herein refer to those illustrated in the accompany drawings, which are only for conveniently describing the invention and simplifying the description, rather than indicate or imply that a device or member has to be in a specific orientation or be configured or operated in a specific orientation. In addition, the terms of “first” and “second” are for the purpose of describing only and should not be constructed to indicate or imply the relative importance. In the present disclosure, the term “some” means two or more than two, unless otherwise expressly stated.

In the present disclosure, unless otherwise expressly stated, the terms “mounted”, “link”, and “connect” should be understood broadly, unless otherwise specified and defined, for example, they may be a fixed connection or a removable connection, they may be mechanical connection or electrical connection, and also intercommunication between two members, they may direct connection, and also indirect connection via a medium, the skilled persons in the art may understand the meanings of above terms according to specific situations.

In the present disclosure, unless otherwise expressly stated, a structure in which a first feature is “on” or “below” a second feature may include an embodiment in which the first feature is in direct contact with the second feature, and may also include an embodiment in which the first feature and the second feature are not in direct contact with each other, but are in contact via an additional feature formed therebetween. Furthermore, a first feature “on,” “above,” or “on top of” a second feature may include an embodiment in which the first feature is directly or obliquely “on,” “above,” or “on top of” the second feature, or just means that the first feature is at a height higher than that of the second feature; while a first feature “below,” “under,” or “on bottom of” a second feature may include an embodiment in which the first feature is directly or obliquely “below,” “under,” or “on bottom of” the second feature, or just means that the first feature is at a height lower than that of the second feature.

The following contents in the present disclosure provide different examples for the implementation of the different structures in this application. To simplify the application, the content below describes the components and settings for a specific example. Nevertheless, the components and settings are only for demonstration purpose, not to be considered as restrictions to this application. Furthermore, the reference number and/or letter in this application can be repetitively used in different examples. It aims to simplify and clarify the application, with no intention on indicating the relationship between different examples and/or settings. In addition, this application provides examples of several different specific technology and material, which can be extended to implementations in other technology and/or material by the technical staff within the same field.

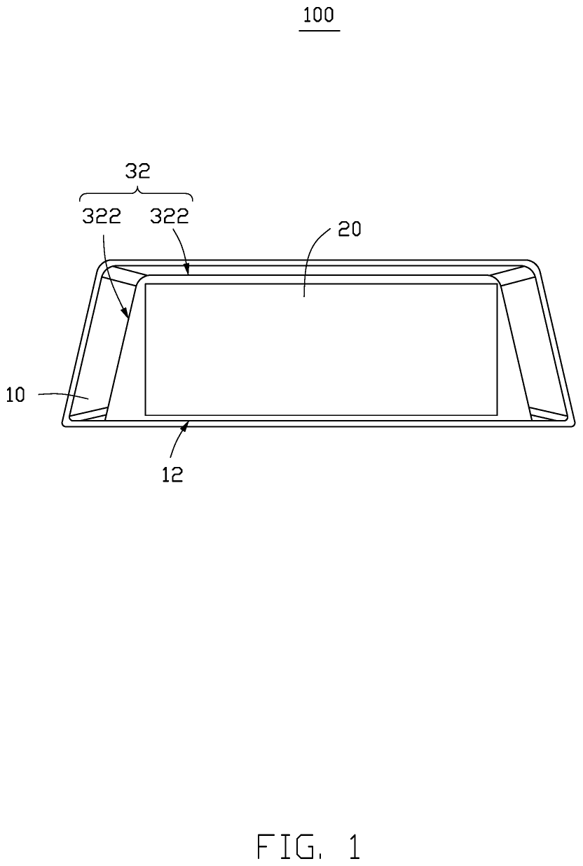

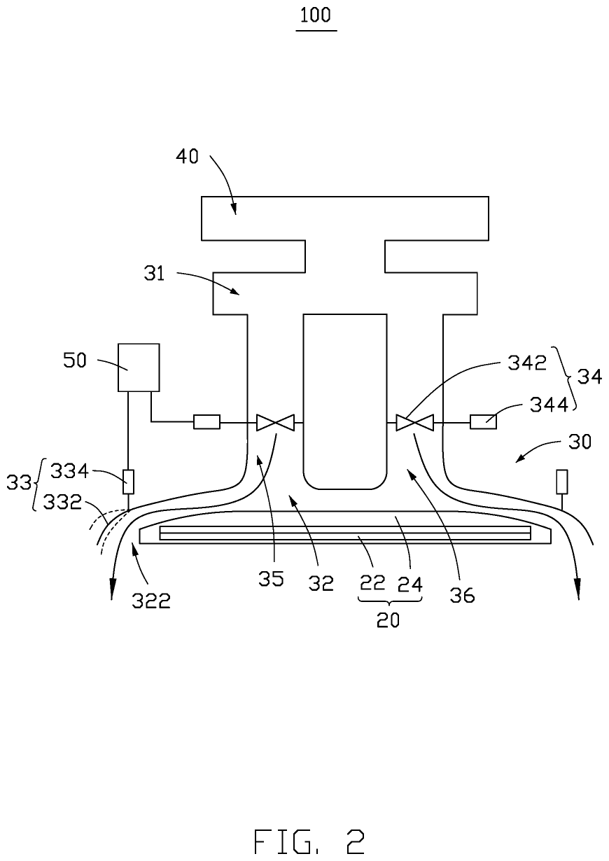

FIGS. 1 and 2 show an instrument panel assembly 100 from different angles. The instrument panel assembly 100 includes a body 10, a display terminal 20, and an air outlet assembly 30.

The body 10 includes a mounting surface 12 facing a driver or passengers. The body 10 can be a central control platform between a driver seat and a front passenger or copilot of a vehicle.

The display terminal 20 is disposed on the mounting surface 12. The display terminal 20 can provide a display function and a touch function. The driver and the passenger can input information or instructions based on the touch function of the display terminal 20. The display terminal 20 or the instrument panel assembly 100 executes actions based on the input information or instructions. The display terminal 20 can be a central display. The display terminal 20 provides human-computer interaction function, navigation function, video play function, and remote control function through a connected mobile phone.

The display terminal 20 includes a display panel 22 and a backlight module 24. The display panel 22 faces the driver and the passengers. The backlight module 24 is disposed on a surface of the display panel 22 away from the driver and the passengers. While using the display terminal 20, the backlight module 24 generates heat, which cause elements in the display panel 22 to heat up. A lifetime of the display panel 22 may be reduced.

The air outlet assembly 30 includes an air intake 31 and an air outlet 32. The air intake 31 is communicating with an air conditioning system 40. The air outlet 32 is disposed on the mounting surface 12. The display terminal 20 is received in the air outlet 32. At least a part of an air outlet region of the air outlet 32 is covered by the display terminal 20. The display terminal 20 connects with the air outlet 32 through several components, or directly connects with a side of the air outlet 32.

The air conditioning system 40 provides hot or cold airflow to the mounting surface 12 of the body 10 through the air outlet assembly 30, providing same to the driver and the passengers through the air outlet 32 at the mounting surface 12. The air outlet region of the air outlet 32 is covered by the display terminal 20, the heat generated by the backlight module 24 of the display terminal 20 is moderated by the hot or cold airflow, thus the display terminal 20 can be kept under a suitable temperature, and the lifetime of the display terminal 20 is improved.

The instrument panel assembly 100 further includes a processor component 50 disposed in the body 10. The processor component 50 is electrically connected to the air outlet assembly 30 and the display terminal 20. The processor component 50 receives information or instructions transmitted by the display terminal 20 and transmits the information or instructions to the air outlet assembly 30 for controlling the air outlet assembly 30, such as directing an airflow and a volume of air through the air outlet assembly 30.

Several sub-air outlets 322 surrounding the display terminal 20 are formed between the display terminal 20 and the air outlet 32. A direction and a volume of the airflow from each sub-air outlet 322 can be adjusted.

In one embodiment, there are three sub-air outlets 322. One sub-air outlet 322 is disposed upon the display terminal 20, and the other two sub-air outlets 322 are disposed at opposite sides of the display terminal 20. The sub-air outlets 322 have different outlet directions and are independent of each other. The sub-air outlets 322 can be turned on together or separately.

In another embodiment, there is one sub-air outlet 322. The sub-air outlet 322 is substantially a U-shape. The sub-air outlet 322 covers the upper and opposite sides of the display terminal 20. In a third embodiment, there are two sub-air outlets 322, the sub-air outlets 322 are independent of each other and are disposed on opposite sides of the display terminal 20.

The air outlet assembly 30 includes a first airflow channel 35, a second airflow channel 36, at least one airflow direction adjustment component 33, and at least one volume adjustment component 34.

The first airflow channel 35 and the second airflow channel are parallel with each other and are insulated from each other in the body 10. The first airflow channel 35 connects between the air intake 31 and the air outlets 32, and the second airflow channel 36 connects between the air intake 31 and the air outlets 32. The first airflow channel 35 and the second airflow channel 36 are connected to a same air intake 31 and a same air outlet 32. Based on the separated arrangement, the first airflow channel 35 and the second airflow channel 36 face different electronic components in the body 10 respectively. A space required for the air outlet assembly 30 is reduced. The first airflow channel 35 and the second airflow channel 36 can provide hot or cold airflow which can exchange heat between the electronic components in the body 10, for cooling or heating the electronic components. Thus, the electronic components are operating under a suitable environment.

The airflow direction adjustment component 33 is disposed at each of the sub-air outlets 322. The airflow direction adjustment component 33 adjusts the direction of the airflow from each of the sub-air outlets 322.

In one embodiment, as shown in FIG. 2, the airflow direction adjustment component includes a rotating component 332 and a rotating driving component 334.

The rotating component 332 is rotatably disposed at the corresponding sub-air outlet 322 away from the display terminal 20. The rotating component 332 can define a curved surface. The curved surface is concave from a view point of the display terminal 20. The rotating component 332 with a curved structure guides the airflow direction of the corresponding sub-air outlet 322.

The rotating driving component 334 connects with the processor component 50 and the rotating component 332. The rotating driving component 334 receives signals from the processor component 50 and drives the rotating component 332 to rotate. An opened and closed angle between the rotating component 332 and the display terminal 20 changes the size of the opening (ADJopening) between the rotating component 332 and the display terminal 20. A minimum value of the ADJopening can be zero.

When the value of the ADJopening is zero, the rotating component 332 has moved towards the display terminal 20 to completely cover the corresponding sub-air outlet 322 under the driving of the rotating driving component 334. The airflow from the corresponding sub-air outlet 332 is cut off. The display terminal 20 and the air outlet assembly 30 are effectively sealed, and dust is prevented from entering the display terminal 20 and the air outlet assembly 30.

When the value of the ADJopening becomes larger, the rotating component 332 moves away from the display terminal 20. The direction of the airflow outputted by the corresponding sub-air outlet 322 is changed according to the rotating component 332. The broken lines in FIG. 2 indicate a path of rotation of the rotating component 332.

In one embodiment, the rotating driving component 334 can be a motor controller.

In other embodiments, the airflow direction adjustment component 33 can be a rotatable grid. The grid can be manually rotated or driven by a driving motor.

In one embodiment, there are two volume adjustment components 34. Each volume adjustment component 34 includes an adjustment component 342 and an adjustment driving component 344.

One adjustment component 342 is disposed in each of the first airflow channel 35 and the second airflow channel 36. The adjustment component 342 can be an electric valve. The adjustment component 342 adjusts the opened and closed angle of the first airflow channel 35 and the second airflow channel 36 based on signals to adjust the respective volumes of the air from the first airflow channel 35 and the second airflow channel 36. Thus, the volumes of the air from the corresponding sub-air outlet 322 is adjusted.

The adjustment driving component 344 connects with the processor component 50 and the adjustment component 342. The adjustment driving component 344 receives signals from the processor component 50 and drives the adjustment component 342 to adjust the opened and closed angles of the adjustment component 342 in relation to the first airflow channel 35 and the second airflow channel 36. The adjustment driving component can be a controller for providing signals.

In other embodiments, there is one adjustment driving component 344, which connects with both adjustment components 342.

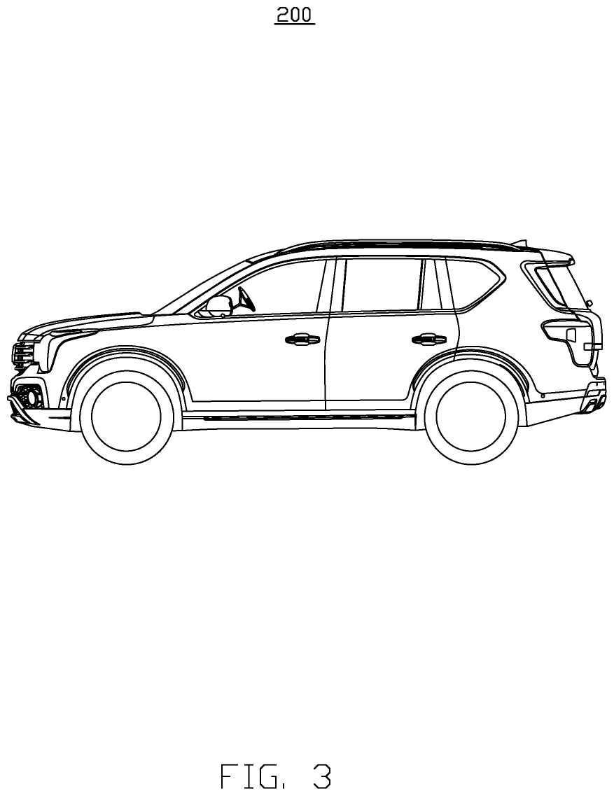

As shown in FIG. 3, a vehicle 200 with the instrument panel assembly 100 is provided. The display terminal 20 is a central display. The vehicle 200 also can be a car, a coach, a truck, or other vehicle.

Based on the structure of the instrument panel assembly 100, the display terminal 20 is embedded in the air outlets 32 in the air conditioning system 40, the size of the display terminal 20 becomes effectively unlimited. Due to the position of the display terminal 20 in the body 10, a risk of mis-operations on the display terminal 20 is reduced while driving. Due to the position of the air outlets 32 in the body 10, cooling and heating effects can be improved. The air outlets 32 of the air conditioning system 40 can adjust heat generated by the display terminal 20 for extending the lifetime of the display terminal 20.

The descriptions of the various embodiments are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An instrument panel assembly mounted in a vehicle; the instrument panel assembly comprises:
a body with a mounting surface;
a display terminal, disposed on the mounting surface; and
an air outlet assembly with an air intake and an air outlet communicated with the air intake; the air intake connects with an air conditioning system; the air outlet is disposed on the mounting surface, and contains the display terminal.

2. The instrument panel assembly of claim 1, wherein the air outlet assembly comprises multiple sub-air outlets formed by the display terminal and the body; the sub-air outlets are configured for adjusting a direction and a volume of airflow from each of the sub-air outlets.

3. The instrument panel assembly of claim 2, wherein the outlet assembly comprises an airflow direction adjustment component disposed at each of the sub-air outlets; the airflow direction component adjusts the direction of the airflow from each of the sub-air outlets.

4. The instrument panel assembly of claim 3, wherein the airflow direction adjustment comprises a rotating component and a rotating driving component; the rotating component is rotatably mounted at each of the sub-air outlets away from the display terminal; the rotating driving component connects with the rotating component; the rotating driving component drives the rotating component to rotate for adjusting an opened and closed angle between the rotating component and the display terminal.

5. The instrument panel assembly of claim 4, wherein the rotating component defines a curved surface; the curved surface is concaved from a view point of the display terminal.

6. The instrument panel assembly of claim 2, wherein the outlet assembly comprises at least one volume adjustment component; the volume adjustment component is disposed between the air intake and the air outlet; the volume adjustment component adjusts a volume of the sub-air outlet.

7. The instrument panel assembly of claim 6, wherein the volume adjustment component comprises an adjustment component and an adjustment driving component; the adjustment component is disposed between the air intake and the air outlet; the adjustment driving component drives the adjustment component to move for adjusting an opened and closed angle between the adjustment component and the air intake or the air outlet.

8. The instrument panel assembly of claim 1, wherein the instrument panel assembly further comprises a processor component; the processor component is disposed in the body; the processor component connects with the air outlet assembly and the display terminal.

9. The instrument panel assembly of claim 1, wherein the air outlet assembly comprises a first airflow channel and a second airflow channel; the first airflow channel connects the air intake and the air outlet; the second airflow channel connects with the air intake and the air outlet, and is parallel with the first airflow channel.

10. A vehicle comprises an instrument panel; the instrument panel comprises:
a body with a mounting surface;
a display terminal, disposed on the mounting surface; and
an air outlet assembly with an air intake and an air outlet communicated with the air intake; the air intake connects with an air conditioning system; the air outlet is disposed on the mounting surface, and contains the display terminal.

11. The vehicle of claim 10, wherein the air outlet assembly comprises multiple sub-air outlets formed by the display terminal and the body; the sub-air outlets are configured for adjusting a direction and a volume of airflow from each of the sub-air outlets.

12. The vehicle of claim 11, wherein the outlet assembly comprises an airflow direction adjustment component disposed at each of the sub-air outlets; the airflow direction component adjusts the direction of the airflow from each of the sub-air outlets.

13. The vehicle of claim 12, wherein the airflow direction adjustment comprises a rotating component and a rotating driving component; the rotating component is rotatably mounted at each of the sub-air outlets away from the display terminal; the rotating driving component connects with the rotating component; the rotating driving component drives the rotating component to rotate for adjusting an opened and closed angle between the rotating component and the display terminal.

14. The vehicle of claim 13, wherein the rotating component defines a curved surface; the curved surface is concaved from a view point of the display terminal.

15. The vehicle of claim 11, wherein the outlet assembly comprises at least one volume adjustment component; the volume adjustment component is disposed between the air intake and the air outlet; the volume adjustment component adjusts a volume of the sub-air outlet.

16. The vehicle of claim 15, wherein the volume adjustment component comprises an adjustment component and an adjustment driving component; the adjustment component is disposed between the air intake and the air outlet; the adjustment driving component drives the adjustment component to move for adjusting an opened and closed angle between the adjustment component and the air intake or the air outlet.

17. The vehicle of claim 10, wherein the instrument panel assembly further comprises a processor component; the processor component is disposed in the body; the processor component connects with the air outlet assembly and the display terminal.

18. The vehicle of claim 17, wherein the air outlet assembly comprises a first airflow channel and a second airflow channel; the first airflow channel connects the air intake and the air outlet; the second airflow channel connects with the air intake and the air outlet, and is parallel with the first airflow channel.
